(19) United States
(12) Patent Application Publication
(10) Pub. No.: US 2025/0173899 A1
(43) Pub. Date: May 29, 2025

(54) SYSTEM AND METHOD FOR CALIBRATING CAMERA

(71) Applicant: HTC Corporation, Taoyuan City (TW)

(72) Inventors: Heng Ding, Taoyuan City (TW); Chao Shuan Huang, Taoyuan City (TW); Kuang-Yu Pan, Taoyuan City (TW)

(73) Assignee: HTC Corporation, Taoyuan City (TW)

(21) Appl. No.: 18/518,631

(22) Filed: Nov. 24, 2023

(51) Int. Cl. G06T 7/80; G06V 20/50

(52) U.S. Cl. CPC G06T 7/80; G06V 20/50; G06T 2207/30244

(57) ABSTRACT

A system and a method for calibrating a camera are provided. The method includes: receiving a plurality of images corresponding to a plurality of calibration charts; generate a virtual calibration chart according to the plurality of images and information of the plurality of calibration charts; receiving a first image captured by a first camera, wherein the first image includes a first calibration chart of the plurality of calibration charts; and calibrating a first parameter of the first camera according to the first image and the virtual calibration chart.

### BACKGROUND

### Technical Field

The disclosure relates to computer vision technology, and particularly relates to a system and a method for calibrating a camera.

### Description of Related Art

Modern computer vision system implementation leverages camera (or camera array system) with wide field of view (FOV) to implement depth estimation and wide FOV, wherein the computer vision system relies on high precision intrinsic parameter and high precision extrinsic parameter of the camera. The intrinsic parameter and the extrinsic parameter can be calibrated by a known geometry (or physical dimension) calibration chart as ground truth.

The intrinsic calibration needs to collect dataset (or chart images) fill whole camera FOV to estimate the coefficients include but not limited to principal point, distortion, and focal length of the camera, thus a camera for the intrinsic calibration needs to take a lot of pictures of a calibration chart in different view angles, as camera 10 shown in FIG. 1, or a huge calibration chart is needed for the intrinsic calibration, as calibration chart 20 shown in FIG. 2.

On the other hand, the extrinsic calibration relies on sharing coordinate system among cameras. In one embodiment shown in FIG. 3, when camera 11 observes points A, B, C, and D and camera 12 observes points B, C, D, and E of a flat calibration chart 20, the pictures taken by the two cameras have overlap at points B, C, and D of the flat calibration chart 20. The extrinsic parameter between camera 11 and camera 12 may be calibrated according to the observation of points B, C, D to estimate two poses of camera 11 and camera 12 in the coordinate system associated with the flat calibration chart 20. However, for some wide FOV camera (or camera array), it is hard to retrieve overlap image by one flat calibration chart. As shown in FIG. 4, the calibration of camera array having camera 11, 12, 13, and 14 cannot be implemented just by the flat calibration chart 20.

### SUMMARY

The disclosure is directed to a system and a method for calibrating a camera.

The present disclosure is directed to a system for calibrating a camera, including a storage medium storing information of a plurality of calibration charts and a processor coupled to the storage medium and the transceiver, wherein the processor is configured to: receive a plurality of images corresponding to the plurality of calibration charts; generate a virtual calibration chart according to the plurality of images and the information; receive a first image captured by a first camera, wherein the first image includes a first calibration chart of the plurality of calibration charts; and calibrate a first parameter of the first camera according to the first image and the virtual calibration chart.

In one embodiment of the present disclosure, the processor is further configured to: generate the virtual calibration chart based on simultaneous localization and mapping algorithm.

In one embodiment of the present disclosure, the processor is further configured to: detect a pattern on the first calibration chart in the first image to obtain an identity of the first calibration chart, wherein the identity is associated with the information; and calibrate the first parameter according to the identity.

In one embodiment of the present disclosure, the first parameter includes an intrinsic parameter of the first camera.

In one embodiment of the present disclosure, the processor is further configured to: receive a second image captured by a second camera, wherein the second camera includes a second calibration chart of the plurality of calibration chart; and calibrate the first parameter of the first camera and a second parameter of the second camera according to the first image, the second image, and the virtual calibration chart.

In one embodiment of the present disclosure, the first parameter includes an intrinsic parameter of the first camera and an extrinsic parameter of the first camera.

In one embodiment of the present disclosure, a first field of view of the first camera is not overlapped with a second field of view of the second camera.

In one embodiment of the present disclosure, the first image further includes a second calibration chart of the plurality of calibration charts.

In one embodiment of the present disclosure, the first calibration chart includes a black grid and a white grid.

In one embodiment of the present disclosure, a first resolution of one of the plurality of images is greater than a second resolution of the first image.

The present disclosure is directed to a method for calibrating a camera, including: receiving a plurality of images corresponding to a plurality of calibration charts; generate a virtual calibration chart according to the plurality of images and information of the plurality of calibration charts; receiving a first image captured by a first camera, wherein the first image includes a first calibration chart of the plurality of calibration charts; and calibrating a first parameter of the first camera according to the first image and the virtual calibration chart.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of taking pictures of a calibration chart.

FIG. 2 illustrates a schematic diagram of a calibration chart with a huge size.

FIG. 3 illustrates a schematic diagram of an extrinsic calibration for two cameras.

FIG. 4 illustrates a schematic diagram of an extrinsic calibration for a camera array.

FIG. 5 illustrates a schematic diagram of a system for calibrating a camera according to an embodiment of the present disclosure.

FIG. 6 illustrates a schematic diagram of generating a virtual calibration chart according to an embodiment of the present disclosure.

FIG. 7 illustrates a schematic diagram of calibrating a camera or a camera array according to an embodiment of the present disclosure.

FIG. 8 illustrates a flowchart of a method for calibrating a camera according to an embodiment of the present disclosure.

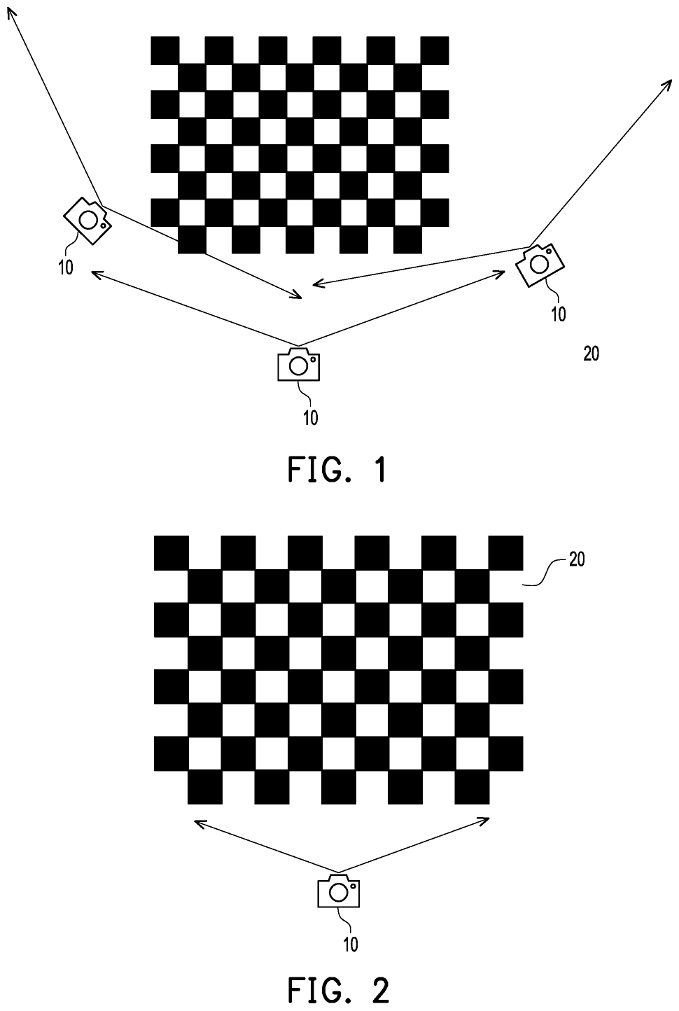

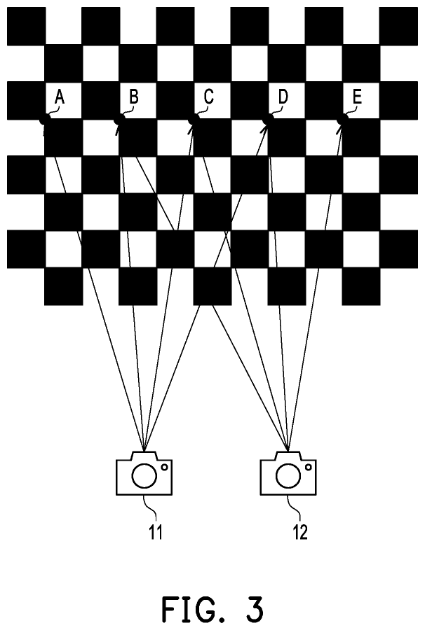

### DESCRIPTION OF THE EMBODIMENTS

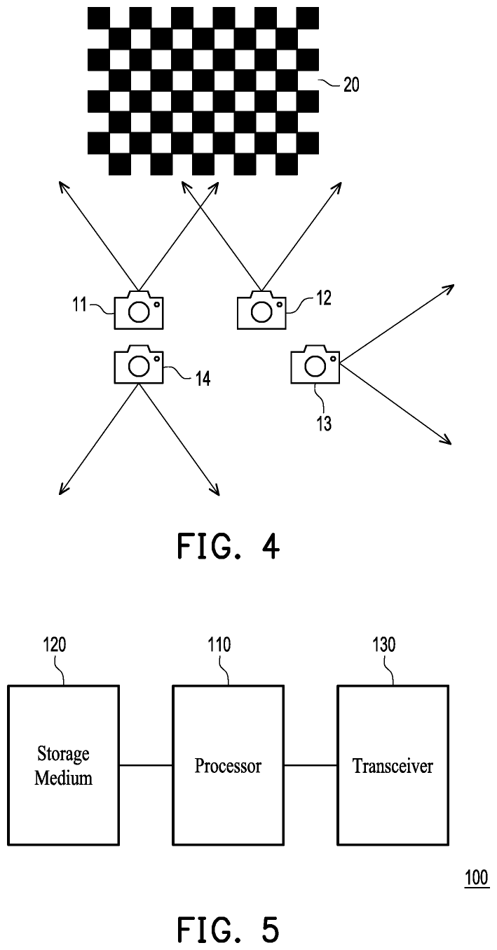

FIG. 5 illustrates a schematic diagram of a system 100 for calibrating a camera according to an embodiment of the present disclosure. The system 100 may include a processor 110, a storage medium 120, and a transceiver 130. The processor 110 may be, for example, a central processing unit (CPU), or other programmable general purpose or special purpose micro control unit (MCU), a microprocessor, a digital signal processor (DSP), a programmable controller, an application specific integrated circuit (ASIC), a graphics unit (GPU), an arithmetic logic unit (ALU), a complex programmable logic device (CPLD), a field programmable gate array (FPGA), or other similar device or a combination of the above devices. The processor 110 may be coupled to the storage medium 120 and the transceiver 130.

The storage medium 120 may be, for example, any type of fixed or removable random access memory (RAM), a read-only memory (ROM), a flash memory, a hard disk drive (HDD), a solid state drive (SSD) or similar element, or a combination thereof. The storage medium 120 may be a non-transitory computer readable storage medium configured to record a plurality of executable computer programs, modules, or applications to be loaded by the processor 110 to perform the function of the system 100.

The transceiver 130 may be configured to transmit or receive wired/wireless signals. The transceiver 130 may also perform operations such as low noise amplifying, impedance matching, frequency mixing, up or down frequency conversion, filtering, amplifying, and so forth. The processor 110 may communicate with other devices (e.g., a camera or a camera array) via the transceiver 130.

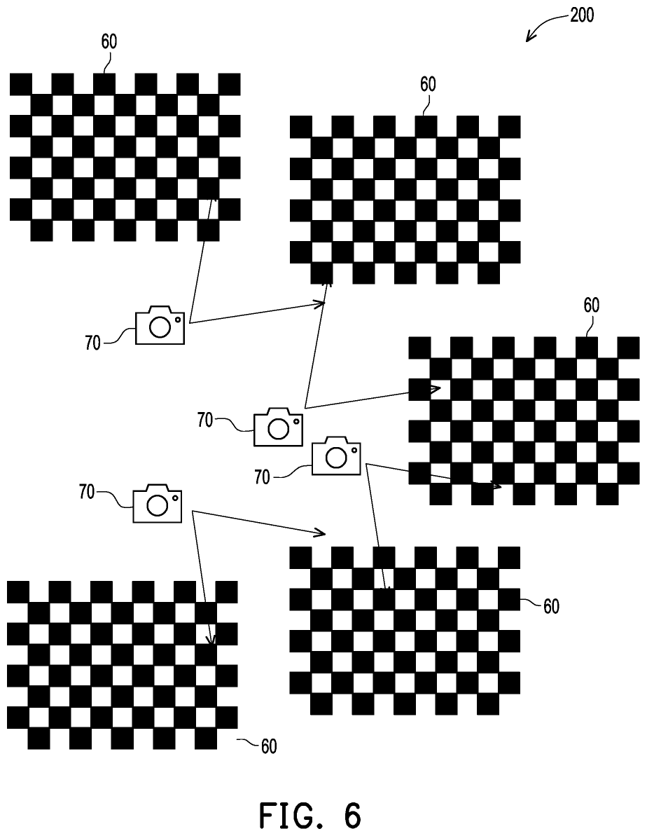

FIG. 6 illustrates a schematic diagram of generating a virtual calibration chart according to an embodiment of the present disclosure. A plurality of calibration charts 60 may be spread in a calibration space 200. The camera 70 for generating the virtual calibration chart may capture a plurality of images corresponding to the plurality of calibration charts 60 in high resolution. Each of the images may include at least a part of one or more calibration charts 60. In one embodiment, a distance between calibration charts 60 may be less than the FOV of the camera 70 such that one or more images captured by the camera 70 may include more than one calibration chart 60. A pattern may be disposed on each calibration chart 60, wherein the pattern may include one or more black grids or white grids. The pattern on each calibration chart 60 may include information of the calibration chart 60 such as the identity of the calibration chart 60. The system may receive the plurality of images captured by the camera 70 through the transceiver 130. The plurality of images and the information of the plurality of calibration charts 60 (e.g., the location of the calibration chart 60, the pattern or grids on the calibration chart 60, the size of the calibration chart 60, or the identity of the calibration chart 60) may be stored in the storage medium 120 of the system 100. For example, the processor 110 may detect a pattern on a calibration chart 60 in an image and obtain the identity of the calibration chart 60 according to the detection result. In one embodiment, the information of the plurality of calibration charts 60 may be received by the system 100 through the transceiver 130.

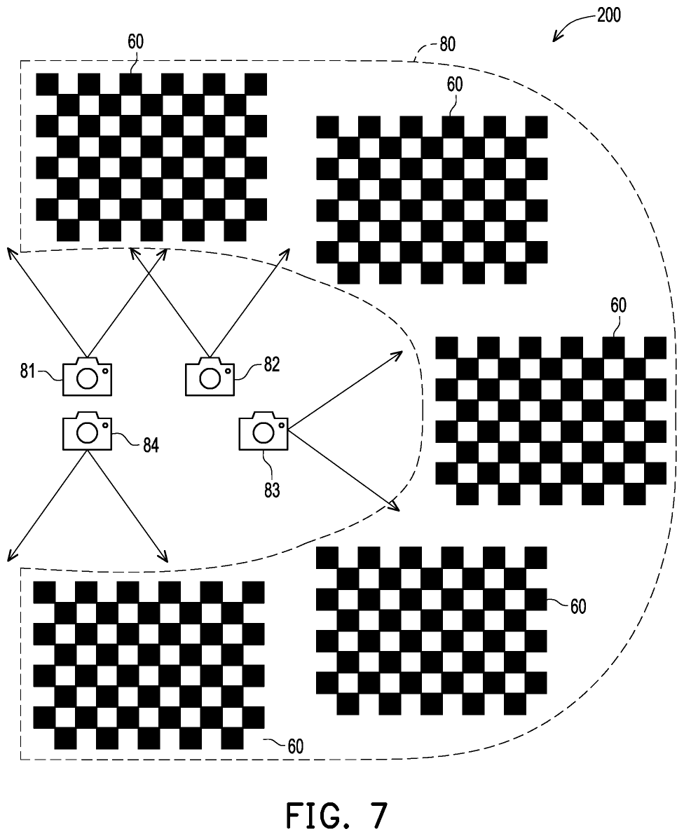

The processor 110 may generate a virtual calibration chart (e.g., virtual calibration chart 80 as shown in FIG. 7) corresponding to the calibration space 200 according to the plurality of images and the information of the plurality of calibration charts 60, wherein the generated virtual calibration chart 80 may include information such as information of each calibration chart 60, a relative position of two calibration charts 60, or the interpolation of the plurality of calibration charts 60. In one embodiment, the processor 110 may generate the virtual calibration chart 80 based on simultaneous localization and mapping (SLAM) algorithm.

FIG. 7 illustrates a schematic diagram of calibrating a camera or a camera array according to an embodiment of the present disclosure. The system 100 may calibrate one camera to be calibrated (e.g., cameras 81, 82, 83, or 84) according to the virtual calibration chart 80. For example, the user may capture, by the camera 81, one or more images of the virtual calibration chart 80 in the calibration space 200. The resolution of the camera to be calibrated (e.g., cameras 81, 82, 83, or 84) may be lower than, equal to, or greater than the resolution of the camera for generating the virtual calibration chart 80 (e.g., camera 70). Accordingly, the resolution of the image captured by the camera to be calibrated may be lower than the resolution of the image captured by the camera for generating the virtual calibration chart 80.

The system 100 may receive one or more images captured by the camera 81, wherein at least one image may include at least a part of one or more calibration charts 60, wherein the multiple calibration charts 60 may be the same as or different from each other. The processor 110 may detect the pattern on the calibration chart 60 in the image captured by the camera 81, so as to obtain information of the calibration chart 60 included in the image such as the identity of the calibration chart 60. After that, the processor 110 may calibrate intrinsic parameters of the camera 81 according to the image captured by the camera 81 and the virtual calibration chart 80 stored in the storage medium 120, wherein the image captured by the camera 81 may include information of one or more calibration charts 60 such as an identity of a calibration chart 60 included in the captured image. The intrinsic parameters of camera 81 calibrated by the processor 110 may include, for example, a focal length, an optical principal point, or distortion of the camera 81.

The system 100 may calibrate a plurality of cameras or a camera array in the same time according to the virtual calibration chart 80. For example, the user may capture, by the camera 82, one or more images of the virtual calibration chart 80 in the calibration space 200, and the user may capture, by the camera 83, one or more images of the virtual chart 80 in the calibration space 200. The system 100 may receive one or more images captured by the camera 82 and one or more images captured by the camera 83, wherein at least one image captured by the camera 82 (and camera 83) may include at least a part of one or more calibration charts 60. The calibration chart 60 captured by the camera 82 may be the same as or different from the calibration chart 60 captured by the camera 83. In other words, the FOVs of the cameras to be calibrated may be overlapped (e.g., FOVs of camera 81 and 82) or not overlapped (e.g., FOVs of camera 82 and 83) with each other.

After that, the processor 110 may calibrate intrinsic parameters or extrinsic parameters of the camera 82 and camera 83 according to the image captured by the camera 81, the image captured by the camera 82 and camera 83, and the virtual calibration chart 80, wherein the image captured by the camera 82 (or camera 83) may include information of one or more calibration charts 60 such as an identity of a calibration chart 60 included in the captured image. The intrinsic parameters of camera 82 (or camera 83) calibrated by the processor 110 may include, for example, a focal length, an optical principal point, or distortion of the camera 82 (or camera 83). The extrinsic parameters of cameras 82 and 83 calibrated by the processor 110 may include, for example, a relative position between camera 82 and camera 83 or the coordinate system of camera 82 and camera 83.

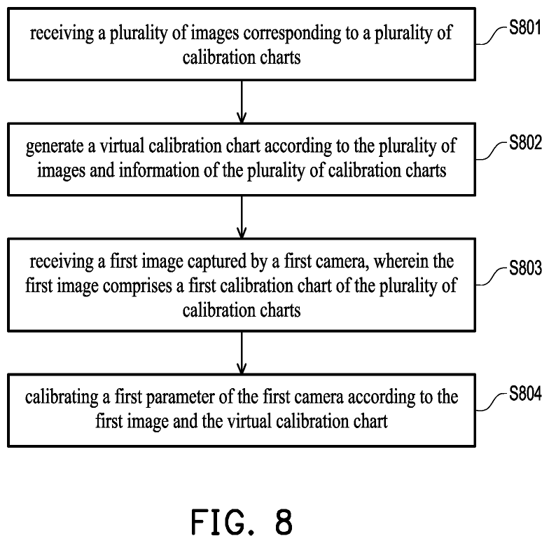

FIG. 8 illustrates a flowchart of a method for calibrating a camera according to an embodiment of the present disclosure, wherein the method may be implemented by the system 100 as shown in FIG. 5. In step S801, receiving a plurality of images corresponding to a plurality of calibration charts. In step S802, generate a virtual calibration chart according to the plurality of images and information of the plurality of calibration charts. In step S803, receiving a first image captured by a first camera, wherein the first image comprises a first calibration chart of the plurality of calibration charts. In step S804, calibrating a first parameter of the first camera according to the first image and the virtual calibration chart.

In summary, the system of the present disclosure may stitch multiple calibration charts distributed in a specific space into a virtual calibration chart as calibration ground truth. After the virtual calibration chart being established, the user may take a picture of the virtual calibration chart by the camera (or camera array) to be calibrated. The system may calibrate the intrinsic parameters or extrinsic parameters of the camera (or camera array) according to the picture of the virtual calibration chart. Accordingly, the user of the camera with wide FOV may not need to prepare a huge calibration chart or may not need to take a lot of pictures of a calibration chart for calibrating the camera. Furthermore, calibration charts with any shapes may be used for the calibration. The calibration of the camera may be performed without high precision computer numerical control (CNC) engineering or unibody mechanical engineering. That is, the present disclosure provides a convenient way for calibrating a camera or a camera array.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A system for calibrating a camera, comprising:
a storage medium, storing information of a plurality of calibration charts; and
a processor, coupled to the storage medium and the transceiver, wherein the processor is configured to:
receive a plurality of images corresponding to the plurality of calibration charts;
generate a virtual calibration chart according to the plurality of images and the information;
receive a first image captured by a first camera, wherein the first image comprises a first calibration chart of the plurality of calibration charts; and
calibrate a first parameter of the first camera according to the first image and the virtual calibration chart.

2. The system of claim 1, wherein the processor is further configured to:
generate the virtual calibration chart based on simultaneous localization and mapping algorithm.

3. The system of claim 1, wherein the processor is further configured to:
detect a pattern on the first calibration chart in the first image to obtain an identity of the first calibration chart, wherein the identity is associated with the information; and
calibrate the first parameter according to the identity.

4. The system of claim 1, wherein the first parameter comprises an intrinsic parameter of the first camera.

5. The system of claim 1, wherein the processor is further configured to:
receive a second image captured by a second camera, wherein the second camera comprises a second calibration chart of the plurality of calibration chart; and
calibrate the first parameter of the first camera and a second parameter of the second camera according to the first image, the second image, and the virtual calibration chart.

6. The system of claim 5, wherein the first parameter comprises an intrinsic parameter of the first camera and an extrinsic parameter of the first camera.

7. The system of claim 5, wherein a first field of view of the first camera is not overlapped with a second field of view of the second camera.

8. The system of claim 1, wherein the first image further comprises a second calibration chart of the plurality of calibration charts.

9. The system of claim 1, wherein the first calibration chart comprises a black grid and a white grid.

10. The system of claim 1, wherein a first resolution of one of the plurality of images is greater than a second resolution of the first image.

11. A method for calibrating a camera, comprising:
receiving a plurality of images corresponding to a plurality of calibration charts;
generate a virtual calibration chart according to the plurality of images and information of the plurality of calibration charts;
receiving a first image captured by a first camera, wherein the first image comprises a first calibration chart of the plurality of calibration charts; and
calibrating a first parameter of the first camera according to the first image and the virtual calibration chart.
